(19) United States
(12) Patent Application Publication
(10) Pub. No.: US 2025/0312992 A1
(43) Pub. Date: Oct. 9, 2025

(54) HEATABLE COMPOSITE PANE WITH ACOUSTICALLY DAMPING PROPERTIES

(71) Applicant: SAINT-GOBAIN GLASS FRANCE, COURBEVOIE (FR)

(72) Inventors: Stephan GIER, HERZOGENRATH (DE); Andrea WILLMS, HERZOGENRATH (DE)

(21) Appl. No.: 18/864,775

(22) PCT Filed: May 17, 2023
(86) PCT No.: PCT/EP2023/063266

§ 371 Date: Nov. 11, 2024

(30) Foreign Application Priority Data
May 24, 2022 (EP) 22175079.7

(51) Int. Cl. B32B 17/10

(52) U.S. Cl. CPC B32B 17/10036; B32B 17/1022; B32B 17/10385; B32B 17/10568; B32B 2305/345; B32B 2307/7376; B32B 2605/00

(57) ABSTRACT

A composite pane includes an outer pane, an inner pane, an acoustic intermediate layer arranged between the inner pane and the outer pane, and a heating element, wherein the acoustic intermediate layer includes, in this order, a thicker layer, a functional layer, and a thinner layer, and the heating element is arranged within the thicker layer, wherein the layer thickness of the thicker layer is at least 10% greater than the layer thickness of the thinner layer.

The invention relates to a heatable composite pane with acoustically damping properties, a method for production thereof, and use thereof.

Composite glass panes are currently used in many places, in particular in the vehicle sector. Here, the term “vehicle” includes, among other things, road vehicles, aircraft, watercraft, agricultural machinery, or even work equipment.

Composite glass panes are also used in other sectors. These include, for example, architectural glazings or information displays, e.g., in museums or as advertising displays.

A composite glass pane generally has two panes that are laminated onto an intermediate layer. The panes themselves can be curved and are usually of constant thickness. The intermediate layer usually comprises a thermoplastic material, preferably polyvinyl butyral (PVB), of a predefined thickness, e.g., 0.76 mm.

In particular in vehicles, but also in buildings, good sound insulation contributes substantially to the quality of the object. Usually, the sound of the external surroundings audible to humans is damped. In this way, for example, the rolling noise of the vehicle itself as well as that of other vehicles is only perceived to a reduced extent in the vehicle interior. In the case of composite panes, this acoustic damping is usually achieved by so-called “acoustic intermediate layers”. The acoustic intermediate layers have a functional layer that absorbs or reflects sound in a specific frequency range.

EP 1 800 855 A1 describes wedge-shaped multi-ply intermediate layers comprising an acoustically damping layer arranged between two protective layers, wherein the wedge shape can be obtained by stretching the multi-ply intermediate layers.

WO 2018/081570 A1, US 2016/0341960 A1, EP 2 017 237 A1, and WO 2020/007610 A1 disclose wedge-shaped multi-ply intermediate layers that comprise a layer of constant thickness and a layer with a wedge-shaped cross-section, wherein the layer of constant thickness includes an acoustically damping layer arranged between two protective layers.

WO 2021/127206 A1 discloses a multi-ply acoustic intermediate layer, wherein the two outer layers are wedge-shaped. In addition, the first outer layer has a layer thickness at least 10% thicker than the second outer layer. Thus, when using the multi-ply acoustic intermediate layer in a head-up display, the optical properties are improved without reducing the noise damping effect.

Another major challenge while driving is the heating of the windshield in order to be able to prevent icing or fogging of the pane, which impedes visibility. The pane is normally heated by heated air blown onto pane via inlets. This type of heating is summarized as the heating, ventilation, and air conditioning (HVAC) method. In addition to the enormous energy consumption, the inlets, via which the hot air is transported and blown onto the pane, require a great deal of space. Furthermore, the outlet nozzles must be installed in a specific geometric relation to the pane, which, in turn, significantly limits design freedom.

Alternatively, the pane itself can have an electrical heating function. From DE 10352464 A1, for example, a composite glass pane is known in which electrically heatable wires are placed between two glass panes as a heating element. The specific heating output can be adjusted by the ohmic resistance of the wires. Because of design and safety aspects, both the number of wires and the diameter of the wires must be kept as small as possible. The wires must not be visible or must be hardly perceivable in daylight and at night with headlight illumination.

WO 2013/035778 A1 discloses a composite pane with an intermediate layer comprising an acoustic PVB film and heating wires, wherein the heating wires are arranged on a glass surface of the composite pane and between the intermediate layer and the glass pane.

Heating elements are usually embedded within the thermoplastic intermediate layer between the outer pane and the inner pane. However, the heating elements can be visually noticeable, in particular when they come into contact with other functional layers that are likewise arranged between the outer pane and the inner pane. The optical distortions that occur in this way reduce the optical quality of the composite pane. The cause of the optical distortions is usually due to different refractive indices for visible light in heating elements and functional layers.

The object of the present invention is, consequently, to provide an improved heatable composite pane that has high optical quality and is largely free of optical distortions.

The object of the present invention is accomplished according to the invention by a composite pane according to claim 1. Advantageous embodiments of the invention are apparent from the subclaims.

The composite pane according to the invention comprises an outer pane, an inner pane, an acoustic intermediate layer, and a heating element. The acoustic intermediate layer is arranged between the inner pane and the outer pane. The acoustic intermediate layer comprises, in this order, a thicker layer, a functional layer, and a thinner layer. The heating element is arranged within the thicker layer. The layer thickness of the thicker layer is at least 10% greater than the layer thickness of the thinner layer. In other words, the layer thickness of the thicker layer is at least 110% of the layer thickness of the thinner layer. Preferably, the thicker layer is arranged closer to the inner pane than to the outer pane. However, the thicker layer can also be arranged closer to the outer pane than to the inner pane. The acoustic intermediate layer preferably has a layer thickness for thermoplastic intermediate layers that is customary for composite panes. Usual layer thicknesses for thermoplastic intermediate layers are generally known to the person skilled in the art. It goes without saying that “heating element arranged within the thicker layer” means that the heating element is completely enclosed by the thicker layer. I.e., the heating element has no contact with the functional layer or the inner pane or the outer pane.

Due to the greater layer thickness of the thicker layer compared to the layer thickness of the thinner layer, the heating element is better embedded within the thicker layer. In this way, contact of the heating element with the functional layer arranged between the thicker layer and the thinner layer is largely avoided. Optical distortions that occur as a result of contact of the heating element with the functional layer are reduced and the optical quality of the composite pane is increased compared to generic composite panes with a symmetrical acoustic intermediate layer. The expression “symmetrical intermediate layer” means that the layer thicknesses of the thicker layer and the thinner layer are the same or deviate from one another by less than 10%.

A further advantage of the invention is that there is also less damage to the composite pane during lamination, since the heating element has no points of contact with the inner pane or the outer pane. As a result of contact of the heating element with the panes, additional stress develops during lamination, which, in the worst case, can lead to breakage of the composite pane. Also, degassing of the intermediate layer, i.e., avoidance of gas inclusions in the intermediate layer, is improved when the heating element is arranged completely within the thicker layer.

The inner pane has an exterior-side surface facing the acoustic intermediate layer and an interior-side surface facing away from the acoustic intermediate layer. The interior-side surface of the inner pane is, at same time, the interior surface of the composite pane. The outer pane has an exterior-side surface facing away from the acoustic intermediate layer, which is, at the same time, the exterior surface of the composite pane. The outer pane also has an interior-side surface facing the acoustic intermediate layer. The composite pane is intended to separate external surroundings from an interior, preferably a vehicle interior. The exterior-side surface of the outer pane is intended to face the external surroundings, and the interior-side surface of the inner pane is intended to face the interior.

In a preferred embodiment of the invention, the layer thickness of the acoustic intermediate layer is from 0.2 mm to 2 mm, preferably 0.4 mm to 1 mm, particularly preferably 0.5 mm to 0.85 mm. “Layer thickness of the acoustic intermediate layer” means the total layer thickness of the thicker layer, the thinner layer, and the functional layer as well as any optional additional layers. In the layer thickness range described for the acoustic intermediate layer, the effect of the invention is particularly strong.

In another preferred embodiment of the invention, the layer thickness of the thicker layer is from 0.1 mm to 1 mm, preferably 0.15 mm to 0.5 mm, particularly preferably 0.2 mm to 0.4 mm. In the layer thickness range described, particularly good embedding of the heating element in the thicker layer is possible.

In another preferred embodiment of the invention, the layer thickness of the functional layer is from 0.01 mm to 0.5 mm, preferably 0.05 mm to 0.2 mm, particularly preferably 0.08 mm to 0.15 mm. The acoustically damping properties of the functional layer are particularly advantageous in this layer thickness range in terms of material consumption and the space required.

Particularly preferably, the layer thickness of the thicker layer is at least 15%, in particular at least 25%, greater than the layer thickness of the thinner layer. The layer thickness of the thicker layer is thus at least 115%, preferably at least 125%, of the layer thickness of the thinner layer. In this layer thickness range, optical distortions caused by the heating element and the functional layer can be further reduced.

The heating element can be an electrically conductive foil, for example, a metallic foil. Preferably, the heating element is implemented as an electrically conductive foil. The electrically conductive foil contains or consists of metal, preferably silver, gold, copper, nickel, and/or chromium or a metal alloy. The heating element particularly preferably contains at least 90 wt.-% of the metal, in particular at least 99.9 wt.-% of the metal. The metal can also be applied as a coating on the electrically conductive foil. In an advantageous embodiment, the metallic coating is an electrically conductive layer or a layer structure of multiple individual layers with a total thickness less than or equal to 2 μm, particularly preferably less than or equal to 1 μm.

The total layer thickness of all electrically conductive layers is preferably from 40 nm to 80 nm, particularly preferably from 45 nm to 60 nm. In this range for the total thickness of all electrically conductive layers, sufficiently high specific heating power P and, at the same time, sufficiently high transmittance are advantageously achieved with typical distances h between two bus bars and an operating voltage U in the range from 12 V to 15 V for vehicle panes, in particular windshields. In addition, the heating element has, in this range for the total thickness of all electrically conductive layers, particularly good reflecting properties for the infrared range. Excessively low total layer thicknesses of all electrically conductive layers result in excessively high sheet resistance and thus in excessively low specific heating power as well as reduced reflecting properties for the infrared range. Excessively large total layer thicknesses of all electrically conductive layers reduce transmittance through the pane too much such that the requirements for transmittance of vehicle windows are not met.

In a preferred embodiment of the invention, the heating element is implemented in the form of thin metal wires that preferably extend over a large part of the area of the composite pane. The wires can even overlap. The diameter of the metal wires is preferably less than 1 mm, particularly preferably less than 0.5 mm, most particularly preferably less than 100 μm, in particular in a range from 10 μm to 30 μm. The metal wires preferably contain at least one metal, preferably, silver, gold, copper, nickel, and/or chromium or a metal alloy. Most particularly preferably, the heating wires contain or are made of tungsten. The heating wires particularly preferably contain at least 90 wt.-% of the metal, in particular at least 99.9 wt.-% of the metal. The effect of optical distortion is particularly significantly reduced when heating wires are used. Since the heating wires can come into localized contact with the functional layer at many different regions of the composite pane. Consequently, a halo effect can occur, which reduces the optical quality of the composite pane. This problem is largely avoided as a result of the solution according to the invention.

The functional layer preferably has greater plasticity or elasticity than the thicker and thinner layer surrounding it. The functional layer thus has a soft core, with the stiffness of the layer structure increasing from the core of the functional layer to the outer surfaces of the thicker layer and the thinner layer. The functional layer with higher elasticity is primarily responsible for the acoustical damping, whereas the thicker layer and the thinner layer having lower elasticity contribute significantly to stabilizing the functional layer. The thicker and the thinner layer also serve as a thermoplastic bonding material to fixedly bond the outer pane to the inner pane.

In a preferred embodiment of the invention, the thicker layer itself can also be formed by multiple layers, preferably two layers such that these multiple layers fuse during lamination to form the thicker layer. This is preferred in particular when the heating element is implemented as an electrically conductive foil. The electrically conductive foil can thus be arranged between the at least two layers of the thicker layer such that the electrically conductive layer is arranged within the thicker layer after lamination according to the invention.

The individual layers of the acoustic intermediate layer, i.e., the thicker layer, the functional layer, and the thinner layer contain, in one embodiment, independently of one another, at least thermoplastic materials, preferably polyvinyl butyral (PVB), ethylene vinyl acetate (EVA), polyvinyl acetate, polyurethane (PU), acrylates, or mixtures or copolymers or derivatives thereof, particularly preferably polyvinyl butyral (PVB), in particular polyvinyl butyral (PVB) and plasticizer.

In a preferred embodiment, the thicker layer, the functional layer, and/or the thinner layer contain polyvinyl butyral and plasticizer. The selection of the plasticizer and the degree of acetalization of the polyvinyl butyral make it possible to influence the elasticity of the polymeric layers in a manner known to the person skilled in the art. Preferably, the functional layer contains a greater percentage of plasticizers than the thicker layer and/or the thinner layer.

The thicker layer, the functional layer, and/or the thinner layer can, independently of one another, be clear and colorless, but also tinted, frosted, or colored. The layers can be completely tinted or colored. Alternatively, the layers can also have a color gradient or a colored pattern. For composite panes that are provided as windshields, the coloring or tinting is implemented such that the composite pane has light transmittance greater than 70% in the spectral range from 380 nm to 780 nm. For composite panes that are provided as roof panels or rear side windows, the coloring or tinting can also be darker, and the composite panes thus have light transmittance of 70% or less in the spectral range from 380 nm to 780 nm. It goes without saying that in embodiments in the case of a windshield, the transmittance outside the vision region, in particular in the region adjacent the roof edge, can also be less than 70%.

Plasticizers are chemical compounds that make plastics softer, more flexible, smoother, and/or more elastic. They shift the thermoelastic range of plastics to lower temperatures such that the plastics have the desired more elastic properties in the range of the temperature of use. Preferred plasticizers are carboxylic acid esters, in particular low-volatility carboxylic acid esters, fats, oils, soft resins, and camphor. Other plasticizers are preferably aliphatic diesters of tri- or tetraethylene glycols. Particularly preferably used as plasticizers are 3G7, 3G8, or 4G7, where the first digit indicates the number of ethylene glycol units and the last digit indicates the number of carbon atoms in the carboxylic acid portion of the compound. Thus, 3G8 represents triethylene glycol-bis-(2-ethyl hexanoate), in other words, a compound of the formula C₄H₉CH (CH₂CH₃) CO (OCH₂CH₂)₃O₂CCH (CH₂CH₃) C₄H₉.

Preferably, the functional layer based on PVB contains at least 3 wt.-%, preferably at least 5 wt.-%, particularly preferably at least 20 wt.-%, even more preferably at least 30 wt.-%, and in particular at least 35 wt.-% of a plasticizer. The plasticizer contains or is made, for example, of triethylene glycol-bis-(2-ethyl hexanoate).

If something is formed “on the basis of” a polymeric material, it consists mostly, i.e., at a rate of at least 50%, preferably at a rate of at least 60%, and in particular at a rate of at least 70% of this material. It can, consequently, also contain other materials, such as stabilizer or plasticizers.

The acoustic intermediate layer preferably has a constant layer thickness. The thicker layer, the thinner layer, and the functional layer preferably have a constant layer thickness. The thicker layer, the functional layer, and/or the thinner layer can, however, also be wedge-shaped. “Wedge-shaped” means that the layers have, in a cross-sectional view, the shape of a wedge. The wedge-shaped layers thus do not have a constant layer thickness, but a variable layer thickness with a thicker first end and a thinner second end. Wedge-shaped layers are preferred in particular when the composite pane is intended to be a component of a projection assembly (e.g., of a head-up display). By means of the wedge-shaped design of the acoustic intermediate layer, double images in the light reflection of the composite pane can be reduced (“light” means visible light).

The thicker layer, the functional layer, and/or the thinner layer can be wedge-shaped extruded thermoplastic layers or wedge-shaped stretched thermoplastic layers. A wedge-shaped stretched layer can be obtained by wedge-stretching. The wedge angle of the thicker layer, the functional layer, and the thinner layer is, independently of one another, preferably 0.1 mrad to 1.0 mrad, particularly preferably 0.3 mrad to 0.7 mrad.

In the context of the invention, in the case of wedge-shaped layers, the respective layer thickness from which the layer thickness difference between the thicker layer and the thinner layer according to the invention is calculated is always based on the region with the thinnest layer thickness for the thicker layer and is always based on the region with the thickest layer thickness for the thinner layer. In other words, if the thicker layer is wedge-shaped and the thinner layer is not wedge-shaped, the thinner end of the thicker layer has a layer thickness at least 10% greater than the thinner layer. If, on the other hand, both the thicker layer and the thinner layer are wedge-shaped, the thinner end of the thicker layer has a layer thickness at least 10% greater than the thicker end of the thinner layer. If only the thinner layer thickness is wedge-shaped, the thicker layer has a layer thickness at least 10% greater than the thicker end of the thinner layer.

In a particularly preferred embodiment, the heating element extends over at least 10%, preferably at least 30%, particularly preferably at least 80%, and in particular at least 90% of the area of the composite pane. As a result of the extension of the heating element over a large part of the composite pane, it can be efficiently heated.

The heating element is preferably electrically connected to at least two external bus bars provided for connection to a voltage source. The heating element is connected to the bus bars such that a current path for a heating current is formed between the bus bars. The bus bars are preferably arranged on two opposite edge regions of the heating element. As a result of the heating of the composite pane by the heating element, the heating variant using the heating, ventilation, and air conditioning (HVAC) method typically used with vehicle panes when the composite pane is installed in a vehicle is rendered superfluous. This reduces the space requirement in a vehicle. Heating by means of HVAC requires supply lines that direct the air, usually heated in the engine compartment, to the composite pane. The supply lines are usually installed in the dashboard of a vehicle and require a great deal of space. However, the electrical heating of the composite pane with the heating element is also advantageous with respect to use in electric vehicles. In electric vehicles, heating the windshield via the heating element means energy savings compared to the electrical heating of air that is directed at the composite pane. Furthermore, there are degrees of freedom in design since the air outlets of HVAC systems have to be positioned in a defined geometric arrangement relative to the glass surface to enable the blower function.

If the heating element of the composite pane according to the invention is implemented as an electrically conductive film, it preferably has sheet resistance less than or equal to 1 ohm/square, particularly preferably from 0.4 ohm/square to 0.9 ohm/square, most particularly preferably from 0.5 ohm/square to 0.85 ohm/square, for example, approx. 0.7 ohm/square. In this range for the sheet resistance, high specific heating powers P are advantageously achieved. In addition, in this range for the sheet resistance, the heating element, when implemented as a coated transparent film, has particularly good reflecting properties for the infrared range.

In a particular embodiment of the invention, the heating element is connected, in an edge region of the outer pane or inner pane, with two bus bars provided for connection to a voltage source such that, between the bus bars, a current path is formed for a heating current. In this context, the heating element preferably extends over 80% or or more, particularly preferably overt 90% or more, of the surface of the composite pane. This arrangement allows most of the composite pane to be heated efficiently.

The bus bars can be implemented as printed and baked conductive structures. The printed bus bars preferably contain at least a metal, a metal alloy, a metal compound, and/or carbon, particularly preferably a noble metal, and in particular silver. The printing paste preferably contains metallic particles, metal particles, and/or carbon and in particular noble metal particles such as silver particles. The electrical conductivity is preferably achieved through the electrically conductive particles. The particles can be situated in an organic and/or inorganic matrix such as pastes or inks, preferably as a printing paste with glass frits.

The layer thickness of the printed bus bars is preferably from 5 μm to 40 μm, particularly preferably from 8 μm to 20 μm, and most particularly preferably from 8 μm to 12 μm. Printed bus bars with these thicknesses are technically easy to realize and have advantageous current carrying capacity.

The width of the bus bars is preferably from 2 mm to 30 mm, particularly preferably from 4 mm to 20 mm, and in particular from 10 mm to 20 mm. Thinner bus bars result in excessively high electrical resistance and thus in excessively high heating of the bus bars during operation. Furthermore, thinner bus bars are difficult to produce by printing techniques such as screen-printing. Thicker bus bars require undesirably high use of material.

The specific resistance pa of the bus bars is preferably from 0.8 μohm·cm to 7.0 μohm·cm and particularly preferably from 1.0 μohm·cm to 2.5 μohm·cm. Bus bars with specific resistances in this range are technically easy to realize and have advantageous current-carrying capacity.

Alternatively, however, the bus bar can also be implemented as a strip of an electrically conductive foil. The bus bar then contains, for example, at least aluminum, copper, tinned copper, gold, silver, zinc, tungsten, and/or tin or alloys thereof. The strip preferably has a thickness of 10 μm to 500 μm, particularly preferably of 30 μm to 300 μm. Bus bars made of electrically conductive foils with these thicknesses are technically easy to realize and have advantageous current carrying capacity. The strip can be electrically conductively connected to the electrically conductive structure, for example, via a solder compound, via an electrically conductive adhesive, or by direct placement.

In a particularly preferred embodiment, the two bus bars are connected to a voltage source such that a current path for a heating current through the heating element is formed between the two bus bars.

The inner pane and the outer pane are preferably made of glass, particularly preferably of soda lime glass, as is common for window panes. The inner pane and the outer pane can, however, also be made of other types of glass, for example, quartz glass, borosilicate glass, or aluminosilicate glass, or of rigid clear plastics, for example, polycarbonate or polymethyl methacrylate.

The inner pane and/or the outer pane can have antireflection coatings, nonstick coatings, scratch-resistant coatings, photocatalytic coatings, electrically heatable coatings, sun-shading coatings, and/or low-E coatings.

The thickness of the outer pane and the inner pane can vary widely and thus be adapted to the requirements in the individual case. The inner pane and the outer pane preferably have thicknesses of 0.5 mm to 5 mm, particularly preferably of 1 mm to 3 mm. For example, the outer pane is 2.1 mm thick; and the inner pane, 1.6 mm thick. However, the outer pane or, in particular, the inner pane can also be thin glass with a thickness of, for example, 0.55 mm.

Preferably, the inner pane and the outer pane have no wedge angle. However, it is also possible for the inner pane and/or the outer pane to have a wedge-shaped cross-section. The wedge angle of the composite pane is composed of the wedge angle of the acoustic intermediate layer, the inner pane, and the outer pane.

The composite pane according to the invention can be a vehicle pane. A vehicle pane is intended to separate a vehicle interior from external surroundings. A vehicle pane is thus a windowpane inserted into or provided in a window opening of the vehicle body. A composite pane according to the invention is, in particular, a windshield of a motor vehicle.

The inner pane and the outer pane can be, independently of one another, clear and colorless, but also tinted, frosted, or colored. The total transmittance through the composite pane is, in a preferred embodiment, greater than 70%, in particular when the composite pane is a windshield. The term “total transmittance” is based on the process for testing the light permeability of motor vehicle windows specified by ECE-R 43, Annex 3, § 9.1. The inner pane and the outer pane can be made, for example, of non-tempered, partially tempered, or tempered glass.

A composite pane according to the invention can, additionally, include a masking print, made in particular from a dark, preferably black, enamel. The masking print is, in particular, a peripheral, i.e., frame-like, masking print. The peripheral masking print serves primarily as UV protection for the mounting adhesive of the composite pane. The masking print can be opaque and cover the entire surface. The masking print can also be designed, at least in sections, semitransparent, for example, as a point grid, strip grid, or checkered grid. Alternatively, the masking print can also have a gradient, for example, from an opaque covering to a semitransparent covering. The masking print is usually applied on the interior-side surface of the outer pane or on the interior-side surface of the inner pane.

The composite pane according to the invention is preferably curved in one or a plurality of spatial directions, as is customary for motor vehicle windows with typical radii of curvature in the range from approx. 10 cm to approx. 40 m. The composite pane can, however, also be flat, for example, when it is provided as a pane for buses, trains, or tractors.

The composite pane according to the invention can, for example, be used as a component of a head-up display (HUD) or another projection assembly for displaying information.

The invention also relates to a method for producing a composite pane, wherein
(A) a layer stack with the outer pane, the acoustic intermediate layer, the heating element, and the inner pane is provided.
(B) The heating element is arranged within the thicker layer, preferably by pressing in.
(C) The layer stack is laminated to form the composite pane.

In a preferred embodiment of the method according to the invention, the thicker layer of the acoustic intermediate layer comprises a first layer and a second layer. In the second step of the method, the heating element is arranged between the first layer and the second layer such that, in the context of the invention, the heating element is arranged within the thicker layer. In the third step, during lamination, the first layer and the second layer fuse to form the thicker layer; and the thicker layer, the thinner layer, and the functional layer fuse to form the acoustic intermediate layer. The heating element is thus arranged within the thicker layer and is completely surrounded by the thicker layer. This embodiment is, in particular, preferred when the heating element is implemented as an electrically conductive foil.

In the context of the invention, “pressing in” means that the heating element is pressed into the thicker layer by means of applied pressure, preferably with simultaneous heating of the thicker layer.

The lamination of the layer stack can be carried out by means of common lamination processes. For example, so-called autoclave methods can be carried out at an elevated pressure of approx. 10 bar to 15 bar and temperatures from 130° C. to 145° C. for roughly 2 hours. Alternatively, autoclave-free methods are also possible. Vacuum bag or vacuum ring methods known per se operate, for example, at roughly 200 mbar and 80° C. to 110° C. The inner pane, acoustic intermediate layer, and the outer pane can also be pressed in a calender between at least one pair of rollers to form a composite pane. Facilities of this type for producing panes are known and normally have at least one heating tunnel upstream from a press. The temperature during the pressing operation is, for example, from 40° C. to 150° C. Combinations of calendering and autoclave methods have proved particularly useful in practice. Alternatively, vacuum laminators can be used. These consist of one or more heatable and evacuable chambers in which the inner pane and the outer pane can be laminated within, for example, about 60 minutes at reduced pressures from 0.01 mbar to 800 mbar and temperatures from 80° C. to 170° C.

If the composite pane is to be curved, the inner pane and the outer pane are preferably subjected to a bending process prior to lamination. Preferably, the inner pane and the outer pane are bent congruently together (i.e., at the same time and by the same tool), since the shape of the panes is thus optimally matched for the subsequent lamination. Typical temperatures for glass bending processes are, for example, 500° C. to 700° C.

The composite pane according to the invention can be, for example, the roof panel, windshield, side window, or rear window of a vehicle or another vehicle glazing, for example, a separating pane in a vehicle, preferably in a rail vehicle, a car, or a bus. Alternatively, the composite pane can be an architectural glazing, for example, in an external façade of a building, or a separating pane in the interior of a building, or a built-in component in furniture or appliances.

The invention is explained in greater detail in the following using exemplary embodiments with reference to the accompanying figures. They depict, in simplified representation, not to scale:

FIG. 1 a plan view of an embodiment of a composite pane according to the invention,

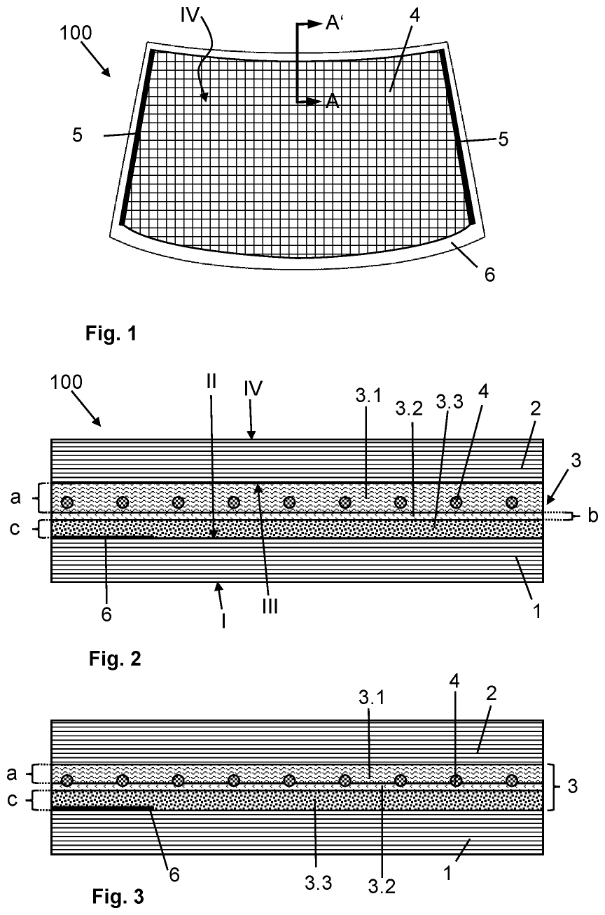

FIG. 2 an enlarged cross-sectional view of the embodiment of FIG. 1,

FIG. 3 an enlarged cross-sectional view of a generic composite pane, and

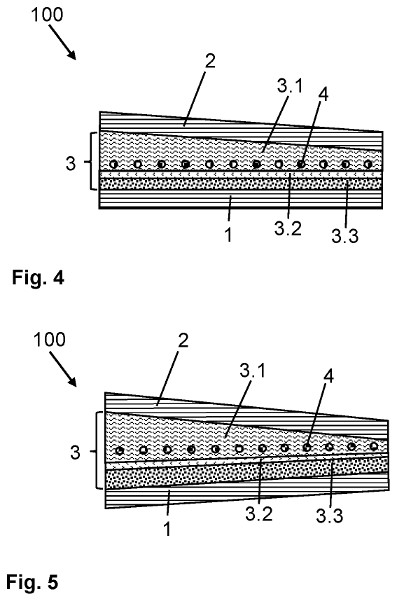

FIG. 4-5 enlarged cross-sectional views of further embodiments of a composite pane according to the invention.

FIG. 1 depicts a plan view of a composite pane 100 according to the invention, in particular for use as a windshield of a motor vehicle. FIG. 2 depicts an enlarged cross-sectional view of the composite pane 100 of FIG. 1 along the section line A-A′ as indicated in FIG. 1.

The composite pane 100 has a heating element 4, which is arranged in the form of heating wires between the outer pane 1 and the inner pane 2. The heating element 4 extends over the entire area of the composite pane 100 with the exception of a circumferential thin edge region with a width, for example, of 1 cm, which serves to electrically insulate the composite pane 100 from the external surroundings. Two bus bars 5 are electrically conductively connected to the heating element 4 at two opposite edge regions of the heating element 4. A first bus bar of the two bus bars 5 is arranged parallel to a left side edge of the composite pane 100. A second bus bar of the two bus bars 5 is arranged parallel to a right side edge of the composite pane 100. The spatial indications “left” and “right” refer here to the position of the bus bars 5 when looking at a surface of the installed composite pane 100 facing the interior. Also possible is an arrangement of the bus bars 5 parallel to an upper edge and to a lower edge of the composite pane 100 (not shown here). The bus bars 5 are provided to be connected to a voltage source such that a heating current can flow between the bus bars 5 and through the heating element 4. The composite pane 100 can thus be heated by the heating element 4 as needed, by which means frost and fogging (condensation) can be removed.

The composite pane 100 additionally has a masking print 6, for example, a dark enamel. The masking print 6 is arranged frame-like in a circumferential edge region of the composite pane 100. The peripheral masking print 6 serves, for example, as UV protection for the mounting adhesive of the composite pane 100. The masking print 6 can be applied to the inner pane 2 or the outer pane 1 (not shown here).

FIG. 2 depicts an enlarged cross-sectional view of the composite pane 100 in an upper edge region, as indicated by the section line A-A′ in FIG. 1. The composite pane 100 comprises an outer pane 1 and an inner pane 2. An acoustic intermediate layer 3 is arranged between the outer pane 1 and the inner pane 2. The outer pane 1 has an exterior-side surface I facing away from the acoustic intermediate layer 3 and an interior-side surface II facing the acoustic intermediate layer 3. The inner pane 2 has an exterior-side surface III facing the acoustic intermediate layer 3 and an interior-side surface IV facing away from the acoustic intermediate layer 3. The exterior-side surface I of the outer pane 1 is also, at the same time, the outer face of the composite pane 100, intended, in the installed position, to face the external surroundings. The interior-side surface IV of the inner pane 2 is also, at the same time, the inner face of the composite pane 100, intended, in the installed position, to face an interior.

The outer pane 1 and the inner pane 2 are made, for example, of transparent soda lime glass. The outer pane has, for example, a thickness of 2.1 mm. The inner pane 2 has, for example, a thickness of 1.6 mm.

The masking print 6 is applied to the interior-side surface II of the outer pane 1. The acoustic intermediate layer 3 comprises, in this order, a thicker layer 3.1, a functional layer 3.2, and a thinner layer 3.3. The thicker layer 3.1 is arranged on the exterior-side surface III of the inner pane 2. Correspondingly, the thinner layer 3.3 is arranged on the interior-side surface II of the outer pane 1. The heating element 4 in the form of heating wires is introduced within the thicker layer 3.1 by means of pressure and heat. The thicker layer 3.1 and the thinner layer 3.3 are made, for example, of thermoplastic material. Preferably, the thicker layer 3.1 and the thinner layer 3.3 are formed on the basis of PVB. The functional layer 3.2 is made, for example, of thermoplastic material and preferably contains PVB. The functional layer 3.2 has, for example, a higher proportion of plasticizers than the thicker and the thinner layer 3.1, 3.3.

The thicker layer 3.1 has, for example, a layer thickness a of 0.353 mm. The thinner layer 3.3 has, for example, a layer thickness c of 0.307 mm. The layer thickness b of the functional layer 3.2 is, for example, 0.1 mm. The layer thickness of the entire acoustic intermediate layer 3 is, for example, 0.76 mm. According to the invention, the layer thickness a of the thicker layer 3.1 is greater than the layer thickness c of the thinner layer 3.3. The layer thickness a of the thicker layer 3.1 is approx. 15% greater than the layer thickness c of the thinner layer 3.3. The greater layer thickness a of the thicker layer 3.1 results in the fact that the heating element 4 can be better embedded in the thicker layer 3.1. The heating element 4 has no contact or at least has essentially no contact with the functional layer 3.2. This results in better optical quality of the composite pane 100. The heating element 4 is less conspicuous visually due to the better embedding in the thicker layer 3.1.

FIG. 3 depicts a generic composite pane 100, which essentially corresponds to the variant of FIGS. 1 and 2, such that here only the differences are discussed and, otherwise, reference is made to the description concerning FIGS. 1 and 2. In contrast to the composite pane 100 depicted in FIG. 2, the thicker and the thinner layer 3.1, 3.3 have the same layer thickness, for example, 0.33 mm. This means: layer thickness a=layer thickness c. The total layer thickness of the acoustic intermediate layer 3 is 0.76 mm. Due to the lower layer thickness a of the thicker layer 3.1 compared to the layer thickness a of the composite pane 100 according to the invention, the heating wires 4 are less well embedded in the layer 3.1. Due to the poorer embedding of the heating element 4 in the thicker layer 3.1, contact of the heating element 4 with the functional layer 3.2 occurs. This results in unevenness of the functional layer 4 and the unevenness becomes visible as optical distortion. For the heating wires of the heating element 4, this means that they are more visible because a kind of halo can be seen at the edge of the heating wires. This adversely affects the optical quality of the composite pane 100.

The variants according to the invention depicted in FIGS. 4 and 5 correspond essentially to the variant of FIGS. 1 and 2 such that here only the differences are discussed and, otherwise, reference is made to the description concerning FIGS. 1 and 2.

Unlike what is shown in FIG. 2, the thicker layer 3.1 in FIG. 4 does not have uniform layer thickness a, but is wedge-shaped. It can be seen that the thicker layer 3.1 has a wedge-shaped cross-section with a thicker first end and a thinner second end. In the embodiment depicted in FIG. 4, the thickness at the thinner second end of the thicker layer 3.1 is, for example, 0.353 mm. The wedge angle of the thicker layer 3.1 is, for example, 0.55 mrad. The thinner layer 3.3 has, for example, a layer thickness c of 0.307 mm. The thickness a of the thicker layer 3.1 is, at the thinner second end, approx. 15% greater than the layer thickness c of the thinner layer 3.3. This at least largely prevents contact of the heating element 4 with the functional layer 3.2.

In the variant depicted in FIG. 5, the thicker layer 3.1, the functional layer 3.2, and the thinner layer 3.3 do not have uniform layer thicknesses a, b, c, but are wedge-shaped. The thicker layer 3.1, the functional layer 3.2, and the thinner layer 3.3 thus have, in the cross-section depicted, in each case a first thicker end and a second thinner end. The second thinner end of the thicker layer 3.1 is, for example, 0.353 mm and the wedge angle of the thicker layer 3.1 is, for example, 0.4 mrad. The second thinner end of the thinner layer 3.3 is, for example, 0.307 mm and the wedge angle of the thinner layer 3.3 is, for example, 0.1 mrad. The second thinner end of the functional layer 3.2 is, for example, 0.09 mm and the wedge angle of the functional layer 3.2 is, for example, 0.1 mrad. This at least largely prevents contact of the heating element 4 with the functional layer 3.2.

### EXAMPLES

In the Examples according to the invention and the generic Comparative Examples, the layer thicknesses of the thicker layer 3.1, the functional layer 3.2, and the thinner layer 3.3 were varied. In each Example, a composite pane 100 is shown, with the Examples according to the invention modeled on the structure of FIG. 2 and the Comparative Examples modeled on the structure of FIG. 3.

TABLE 1

| | Layer Thickness in mm | | | | | |
|---|---|---|---|---|---|---|
| | Example | Example | Example | Comparative | Comparative | Comparative |
| Layer | 1 | 2 | 3 | Example 1 | Example 2 | Example 3 |
| Inner pane | 1.6 | 1.6 | 1.6 | 1.6 | 1.6 | 1.6 |
| Thicker | 0.214 | 0.353 | 0.396 | 0.200 | 0.330 | 0.370 |
| layer | | | | | | |
| Functional | 0.10 | 0.10 | 0.10 | 0.10 | 0.10 | 0.10 |
| layer | | | | | | |
| Thinner | 0.186 | 0.307 | 0.344 | 0.200 | 0.330 | 0.370 |
| layer | | | | | | |
| Outer pane | 2.1 | 2.1 | 2.1 | 2.1 | 2.1 | 2.1 |
| Optical | No | No | No | Yes | Yes | Yes |
| defect? | | | | | | |

“Optical defects” means increased optical distortions or halo effects, which occur due to contact of the heating element 4 with the functional layer 3.2. By means of the thicker layer thickness a of the thicker layer 3.1 compared to the layer thickness c of the thinner layer 3.3, optical defects that occur in connection with the heating element 4 and the functional layer 3.2 can demonstrably be at least largely avoided.

### LIST OF REFERENCE CHARACTERS

1 outer pane
2 inner pane
3 acoustic intermediate layer
3.1 thicker layer
3.2 functional layer
3.3 thinner layer
4 heating element
5 bus bar
6 masking print
100 composite pane
I exterior-side surface of the outer pane 1
II interior-side surface of the outer pane 1
III exterior-side surface of the inner pane 2
IV interior-side surface of the inner pane 2
a layer thickness of the thicker layer 3.1
b layer thickness of the functional layer 3.2
c layer thickness of the thinner layer 3.3
A-A′ section line

1. A composite pane, comprising:
an outer pane,
an inner pane,
an acoustic intermediate layer arranged between the inner pane and the outer pane, and
a heating element,
wherein the acoustic intermediate layer comprises, in this order, a thicker layer, a functional layer, and a thinner layer, and the heating element is arranged within the thicker layer,
wherein a layer thickness of the thicker layer is at least 10% greater than a layer thickness of the thinner layer.

2. The composite pane according to claim 1, wherein the layer thickness of the acoustic intermediate layer is from 0.2 mm to 2 mm.

3. The composite pane according to claim 1, wherein the layer thickness of the thicker layer is from 0.1 mm to 1 mm.

4. The composite pane according to claim 1, wherein the layer thickness of the functional layer is from 0.01 mm to 0.5 mm.

5. The composite pane according to claim 1, wherein the layer thickness of the thicker layer is at least 15% greater than the layer thickness (e) of the thinner layer.

6. The composite pane according to claim 1, wherein the heating element is implemented in the form of an electrically conductive foil.

7. The composite pane according to claim 1, wherein the heating element is implemented in the form of wires.

8. The composite pane according to claim 1, wherein the thicker layer and/or the thinner layer contains or consists of polyvinyl butyral, ethylene vinyl acetate, polyvinyl acetate, and/or polyurethane.

9. The composite pane according to claim 1, wherein the functional layer has a higher proportion of plasticizers than the thicker and the thinner layer.

10. The composite pane according to claim 1, wherein the thicker layer and/or the thinner layer are wedge-shaped.

11. The composite pane according to claim 1, wherein the heating element extends over at least 80% of the area of the composite pane.

12. The composite pane according to claim 1, wherein the heating element is electrically conductively connected to at least two bus bars in two opposite edge regions.

13. The composite pane according to claim 12, wherein the two bus bars are connected to a voltage source such that, between the two bus bars, a current path through the heating element is formed for a heating current.

14. A method for producing a composite pane according to claim 1, the method comprising;
providing a layer stack with the outer pane, the acoustic intermediate layer, the heating element, and the inner pane,
arranging the heating element within the thicker layer, and
laminating the layer stack to form the composite pane.

15. A method comprising providing a composite pane according to claim 1 in a vehicle of locomotion for travel on land, in the air, or on water or as a functional and/or decorative individual piece or as a built-in component in furniture, appliance, or a building.

16. The composite pane according to claim 2, wherein the layer thickness of the acoustic intermediate layer is from 0.4 mm to 1 mm.

17. The composite pane according to claim 3, wherein the layer thickness of the thicker layer is from 0.15 mm to 0.5 mm.

18. The composite pane according to claim 4, wherein the layer thickness of the functional layer is from 0.05 mm to 0.2 mm.

19. The composite pane according to claim 5, wherein the layer thickness of the thicker layer is at least 25% greater than the layer thickness of the thinner layer.

20. The method according to claim 15, wherein the composite pane is a windshield, a rear window, a side window, and/or a roof panel.
